(19) United States
(12) Patent Application Publication
(10) Pub. No.: US 2010/0037478 A1
(43) Pub. Date: Feb. 18, 2010

(54) LAUNDRY DRYER

(75) Inventors: Andrei Uhov, St-Petersburg (RU); Sergey Leonenkov, St-Petersburg (RU); Claudio Cenedese, Pasian Di Prato (IT); Rica Pantermehl, Nuernberg (DE); Monica Celotto, Motta di Livenza (IT)

Correspondence Address: BANNER & WITCOFF, LTD.;ATTORNEYS FOR CLIENT NOS. 006912 AND 026912, 1100 13th STREET, N.W., SUITE 1200, WASHINGTON, DC, 20005-4051, US

(73) Assignee: ELECTROLUX HOME PRODUCTS CORPORATION N.V., Zaventem (BE)

(21) Appl. No.: 12/521,950

(22) PCT Filed: Dec. 19, 2007
(86) PCT No.: PCT/EP07/11185

§ 371 Date: Jul. 1, 2009

(30) Foreign Application Priority Data
Jan. 8, 2007 (EP) 07100255.4

(51) Int. Cl. F26B 11/02

(52) U.S. Cl. 34/108

(57) ABSTRACT

A laundry dryer (1), wherein the laundry is dried inside a rotating drum (3) by a stream (7) of hot air blown into the drum (3) through a perforated wall (5) of the drum (3); and wherein two single-pole ion generators (10, 11) are located along a path of the stream (7) of air, close to the perforated wall (5), and generate respective streams of ions of opposite polarities, which are blown, together with the air, into the drum (3) to eliminate the electrostatic charge produced in the laundry by the drying process.

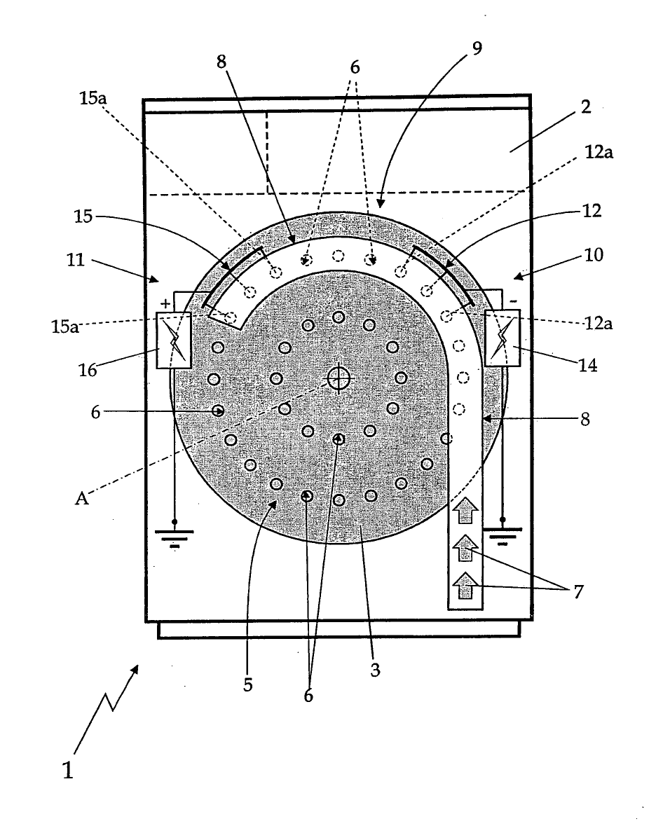

### TECHNICAL FIELD

The present invention relates to a laundry dryer.

More specifically, the present invention relates to a laundry dryer of the type comprising a frame; a drum for containing the laundry to be dried, the drum having a perforated wall and being fitted in axially rotating manner to the frame; a ventilation circuit defining a feed path for a stream of air, and having an outlet communicating with the inside of the drum through the perforated wall; and a heat source associated with the ventilation circuit to heat the air.

Drying an article, normally laundry, by feeding hot air through it is known to result in the accumulation of electrostatic charges, produced triboelectrically, on the article.

It is an object of the present invention to provide a laundry dryer designed to eliminate such electrostatic charges.

According to the present invention, there is provided a laundry dryer as claimed in Claim 1 and, preferably, in any one of the following Claims depending directly or indirectly on Claim 1.

The present invention will be described with reference to the attached drawing, which shows a side view, with parts removed for clarity, of a preferred embodiment of the present invention.

Number 1 in the attached drawing indicates as a whole a laundry dryer, which is particularly advantageous for home use, and which substantially comprises a frame 2 resting on the floor; and a substantially cylindrical drum 3, which is fitted to frame 2 to rotate about a respective longitudinal axis A, and comprises an end wall 5 having a number of holes 6 through which to feed hot air into drum 3.

For this purpose, dryer 1 comprises a heat source (not shown) associated with a ventilation circuit, which defines a feed path for an air stream 7, and which has an outlet 8 extending partly in front of end wall 5 and communicating with the inside of drum 3 through holes 6 to feed the hot air into drum 3.

Dryer 1 also comprises an ion-generating device 9 located at outlet 8 to generate a stream of positive and negative ions, which are blown, together with the hot air, into drum 3 to eliminate the electrostatic charge produced in the laundry by triboelectrification during the drying process.

As shown in the attached drawing, device 9 comprises two single-pole ion generators 10 and 11, each of which generates on command a stream of ions having a given electrostatic charge.

More specifically, ion generator 10 comprises a ion-emitting electrode 12 and a high-voltage source 14 which is connected to the ion-emitting electrode 12 to keep the latter to a given electric potential so as to generate, via The Corona effect, a stream of ions having a given electrostatic charge.

Whereas, ion generator 11 comprises a ion-emitting electrode 15 and a high-voltage source 16 which is connected to the ion-emitting electrode 15 to keep the latter to a given electric potential being opposite in sign to that of ion-emitting electrode 12, so as to generate, via the Corona effect, a second stream of ions having an electrostatic charge opposite in sign to that of ions stream generated by ion generator 10.

More specifically, in the example shown high-voltage source 14 is provided with two terminals between which it maintains a given electric potential difference, preferably, though not necessarily, equal to 5 kVolt. The higher electric potential terminal is set to a given reference electric potential (preferably, though not necessarily, matching with electric potential of frame 2), for example to ground. The lower electric potential terminal is electrically connected to ion-emitting electrode 12 so as to generate a stream of positive ions.

In turn, high-voltage source 16 is provided with two terminals between which it maintains a given electric potential difference, preferably, though not necessarily, equal to 5 kVolt. The lower electric potential terminal is set to said reference electric potential (preferably, though not necessarily, matching with electric potential of frame 2), for example to ground. The higher electric potential terminal is electrically connected to ion-emitting electrode 15 so as to generate a stream of negative ions.

In addition to the above, ion-emitting electrodes 12 and 15 of ion generators 10 and 11 are arranged in series along the feed path of the hot-air stream 7, at a given distance one from the other and facing end wall 5, so as to be skimmed by hot air blown into drum 3 through holes 6.

With reference to the attached drawing, in the example shown both ion-emitting electrodes 12 and 15 are substantially comb-shaped and are provided with a number of pointed free ends 12a, 15a, each of which is positioned in front of end wall 5 of drum 3 to face in sequence, during rotation of drum 3, a number of consecutive holes 6 distributed along a circular path, so that ions—formed, as is known, close to the pointed free ends 12a and 15a of electrodes 12 and 15—are carried easily to the laundry by the stream of hot air blown into drum 3 through holes 6.

More specifically, in the example shown both ion-emitting electrodes 12 and 15 are provided with a respective array of needles 12a, 15a extending side by side in front of, and parallel to, end wall 5 of drum 3, so as to face in sequence, during rotation of drum 3, a number of consecutive holes 6 distributed on end wall 5.

In connection with the above, it should be pointed out that using two single-pole generators 10 and 11 has considerable advantages as compared with one two-pole generator, which may be used for the same purpose. Using a two-pole generator as opposed to the two single-pole generators 10 and 11 in a laundry dryer involves several drawbacks, mainly due to the complex nature of two-pole generators, their relatively high cost, and the poor efficiency of at least the less sophisticated types; the latter drawback being due to the fact that, on account of the structure of the generator itself, many of the ions tend to recombine as soon as they are generated, thus greatly reducing the number of positive and negative ions reaching the laundry to neutralize the electrostatic charge.

On the contrary, the use of two independent single-pole generators 10 and 11 allows to space out the ion-emitting electrodes along air stream 7, optimizing ionization of hot air entering into drum 3.

1. A laundry dryer comprising a frame; a drum for containing the laundry to be dried, the drum having a perforated wall and being fitted in axially rotating manner to the frame; a ventilation circuit defining a feed path for a stream of air, and having an outlet communicating with the inside of the drum through the perforated wall; and a heat source associated with the ventilation circuit to heat the air; the laundry dryer being characterized by comprising an ion-generating device to eliminate from the laundry the electrostatic charge produced by the drying process; the ion-generating device being located close to said outlet, and comprising a first and a second single-pole generator for generating positive ions and negative ions respectively.

2. A laundry dryer as claimed in claim 1, wherein both first and second single-pole generators comprise an ion-emitting electrode and a high-voltage source which is connected to the ion-emitting electrode to keep said ion-emitting electrode to a given electric potential difference with respect to a reference electric potential; the electric potential of the ion-emitting electrode of said first single-pole generator being opposite in sign to that of the ion-emitting electrode of said second single-pole generator.

3. A laundry dryer as claimed in claim 2, wherein the ion-emitting electrode of said first single-pole generator and the ion-emitting electrode of said second single-pole generator are arranged in series along the feed path of said hot-air stream, facing the perforated wall of said drum.

4. A laundry dryer as claimed in claim 3, wherein the ion-emitting electrodes of said first and second single-pole generator are each provided with a plurality of pointed free ends, each of which is faced toward the perforated wall of said drum.

5. A laundry dryer as claimed in claim 4, wherein the perforated wall of said drum has a number of holes through which air is fed into the drum; each pointed free end facing in sequence a number of holes during rotation of the drum.

6. A laundry dryer as claimed in claim 4, wherein said plurality of pointed free ends are provided on an array of needles extending side by side in front of said perforated wall.

7. A laundry dryer as claimed in claim 5, wherein said plurality of pointed free ends are provided on an array of needles extending side by side in front of said perforated wall.
